(19) United States
(12) Patent Application Publication
(10) Pub. No.: US 2015/0155090 A1
(43) Pub. Date: Jun. 4, 2015

(54) TRANSFORMER

(71) Applicant: ALSTOM Technology Ltd, Baden (CH)

(72) Inventors: Alistair Burnett, Tywyn (GB); Robert Riley, Staffordshire (GB)

(73) Assignee: ALSTOM TECHNOLOGY LTD, Baden (CH)

(21) Appl. No.: 14/409,398

(22) PCT Filed: Jul. 3, 2013
(86) PCT No.: PCT/EP2013/064065

§ 371 Date: Dec. 18, 2014

(30) Foreign Application Priority Data
Jul. 4, 2012 (EP) 12275102.7

(51) Int. Cl. H01F 27/28

(52) U.S. Cl. CPC H01F 27/2804; H01F 27/288; H01F 2027/2809

(57) ABSTRACT

A transformer (30) comprises: first and second printed circuit board substrates, the first printed circuit board substrate (32) including at least one first substrate layer (34) having a dielectric relative permittivity of less than or equal to 3.5 and the second printed circuit board substrate including at least one second substrate layer (70) having a dielectric relative permittivity that is higher than the dielectric relative permittivity of the or each first substrate layer (34); and a plurality of electrically conductive traces, at least one electrically conductive trace being patterned on a surface of the first substrate layer (34) or one of the first substrate layers (34) to form a second winding portion (52) and at least one other electrically conductive trace being patterned on a surface of the second substrate layer (70) or one of the second substrate layers (70) to form a first winding portion (50), the first and second winding portions (50,52) defining mutually coupled first and second windings, wherein the first winding is formed by one or more first winding portions (50), the second winding is formed by one or more second winding portions (52), the second winding is formed on the first substrate layer (34) or at least one of the first substrate layers (34), and the first winding is formed on the second substrate layer (70) or at least one of the second substrate layers (70).

The invention relates to a transformer.

High voltage equipment, such as power electronic converters, typically rely on a variety of electrical isolation methods to supply power and signals to various components of the high voltage equipment such as switching, protection and auxiliary circuits. For example, in power electronic converters, power semiconductor devices are used to facilitate power conversion between AC and DC networks, and each power semiconductor device requires its own power supply to energise its control and protection circuits, which are referenced to the voltage potential of its gate drive or base drive electronics. It is however impractical to connect the power supply of each power semiconductor device to the ground level voltage power supply system due to the difference in voltage levels between the power supply system and the individual components of the high voltage equipment.

One solution is to self-power the power electronic converter by harvesting power from each level, but this requires local isolation between components on the same level if each level utilises more than one power semiconductor switching device.

Power electronic converters include high numbers of power semiconductor devices to enable the formation of complex voltage waveforms so as to improve power conversion quality and to achieve a desired power rating. The high number of power semiconductor devices in the power electronic converter requires a high number of transformers to provide power to each power semiconductor device. This leads to an overall increase in converter size and weight because the structure of conventional transformers tends to be physically large when required to accommodate high voltage levels.

In addition, the manufacture of these conventional transformers tends to involve manufacturing methods with low production capacity and poor yield, such as hand-crafted potting and vacuum impregnation.

For example, in cast resin ferrite transformers, the ferrite core cannot be encapsulated in a completely rigid setting resin because magnetisation of the magnetic core causes it to mechanically flex, and inhibiting this mechanical flexing is detrimental to the core's magnetic characteristics. Moreover, curing forces of the resin can fracture or crack the core, thus ruining its performance. Great skill and care is also required to manufacture the cast resin ferrite transformers with high yield, since it is necessary to cast the resin to be void-free in order to produce a competitively sized transformer that can withstand high electrical stress.

According to a first aspect of the invention, there is provided a transformer comprising:
first and second printed circuit board (PCB) substrates, the first printed circuit board substrate including at least one first substrate layer having a dielectric relative permittivity of less than or equal to 3.5 and the second printed circuit board substrate including at least one second substrate layer having a dielectric relative permittivity that is higher than the dielectric relative permittivity of the or each first substrate layer; and
a plurality of electrically conductive traces, at least one electrically conductive trace being patterned on a surface of the first substrate layer or one of the first substrate layers to form a second winding portion and at least one other electrically conductive trace being patterned on a surface of the second substrate layer or one of the second substrate layers to form a first winding portion, the first and second winding portions defining mutually coupled first and second windings,
wherein the first winding is formed by one or more first winding portions, the second winding is formed by one or more second winding portions, the second winding is formed on the first substrate layer or at least one of the first substrate layers and the first winding is formed on the second substrate layer or at least one of the second substrate layers.

The transformer may be, for example, in the form of a mains transformer or in the form of coupled inductors for a flyback converter.

The inventor has found that forming the second winding on a first substrate layer with a dielectric relative permittivity of less than or equal to 3.5 provides a reliable insulation barrier between the second winding and a magnetic core that is arranged, in use, about the windings.

When the transformer is used with a magnetic core, the second winding formed on a first substrate layer is separated from the magnetic core by a length of the first substrate layer and any air gap that is formed between the first substrate layer and the magnetic core. This air gap may be formed as part of the transformer design, or may arise unintentionally due to movement of the magnetic core relative to each winding. Also, movement of the magnetic core relative to each winding may cause the air gap to vary in size.

In use, the formation of the second winding on a first substrate layer advantageously reduces the voltage across an air gap that is formed between the first substrate layer and the magnetic core. This is because the differential voltage applied between the second winding and the magnetic core is shared among the length of the first substrate layer and the air gap that separate the second winding and the magnetic core using resistive and capacitive voltage division, and the low dielectric relative permittivity of the first substrate layer leads to a more balanced voltage division between the length of the first substrate layer and the air gap that separate the second winding and the magnetic core. This prevents the occurrence of partial discharge within the air gap, which would otherwise lead to electrical breakdown, resulting in transformer failure.

The use of PCB technology permits the combination of the first PCB substrate with other types of PCB substrates. The second PCB substrate is used to accommodate one or more first winding portions, for which insulation is not critical. For example, the second PCB substrate may be made from FR-4, which is typically cheaper than PTFE.

In embodiments of the invention, the first winding may be separated from the second winding by at least one first substrate layer.

The inventor has also found that the use of at least one first substrate layer with a dielectric relative permittivity of less than or equal to 3.5 provides a reliable insulation barrier between different windings of the transformer when the different windings are separated by at least one first substrate layer.

In use, the arrangement of at least one first substrate layer to separate the first and second windings advantageously reduces the voltage across air voids that are formed in the or each first substrate layer. This is because the differential voltage applied across the or each first substrate layer is shared among the or each first substrate layer and the air voids using resistive and capacitive voltage division, and the low dielectric relative permittivity of the or each first substrate layer leads to a more balanced voltage division between the or each first substrate layer and the air voids. This prevents the occurrence of partial discharge within the air voids, which would otherwise erode the insulation surrounding the air voids over the short term until electrical breakdown occurs, resulting in transformer failure.

The use of at least one first substrate layer with a dielectric relative permittivity of less than or equal to 3.5 therefore not only provides a reliable insulation barrier between the second winding and a magnetic core that is arranged, in use, around the windings, but also between the first and second windings of the transformer. This in turn allows higher differential voltages to be applied across the insulation barrier, which results in a transformer with increased isolation for signal or power transfer.

The dielectric relative permittivity of the or each first substrate layer is preferably less than or equal to 3, and even more preferably less than or equal to 2.5.

The use of the first and second PCB substrates results in a planar transformer that is lightweight and relatively small in size, and is thereby easily transported to and from the converter station for installation or maintenance purposes. The compact profile and low weight of the planar transformer also leads to an overall size and weight reduction in equipment, into which the planar transformer is incorporated, which is beneficial in certain power applications with restrictions on converter station footprint, e.g. offshore wind farms.

Moreover, the use of PCB technology allows for simple design of the transformer structure at relatively low cost in order to operate at higher voltage levels, when compared to the design and manufacture of conventional transformers which require hand crafted potting or vacuum impregnation methods. This, coupled with the mass production capability of PCB technology, allows the manufacture of a high quality planar transformer using a consistent, repeatable manufacturing process with high yield and fast production lead times.

Each electrically conductive trace may have a copper-based composition, which is suitable for transformer applications due to the excellent thermal and electrical characteristics of copper.

Each winding may have a different number of turns to that of the other winding. This results in a transformer with voltage step-up or step-down capability. The step-up or step-down in voltage between the different windings is dependent on the ratio of the number of turns in one winding to the other.

In use, the magnetic field generated by each winding is proportional to the number of turns of the winding. As such, the number of turns in each winding may be adjusted to modify the strength of the magnetic field so as to provide optimal performance of the transformer.

Preferably the transformer further includes a magnetic core. Each printed circuit board substrate may be shaped to include one or more openings to receive the magnetic core. This allows the magnetic core to be held in a specific position relative to each winding portion. For example, the magnetic core may be received in each PCB substrate such that each winding portion surrounds a portion of the magnetic core.

Each electrically conductive trace may be patterned onto a surface of one of the substrate layers to form a winding portion that is arranged about the opening into which the magnetic core is inserted. This improves the mutual coupling between the different windings and thereby aids the transfer of electrical power between the windings.

The magnetic core may be made from different types of magnetic materials. For example, the magnetic core may have a ferrite-based composition. The high frequency performance of ferrite-based magnetic cores leads to a reduced size and a more efficient performance of the planar transformer and any supporting circuitry.

The magnetic core may be configured to have a variety of shapes to permit its assembly with each PCB substrate in a manner that results in a robust transformer assembly. For example, the magnetic core may include first and second core elements, the first core element having an E shape and the second core element having an E or I shape, or each of the first and second core elements having an ER shape.

In embodiments of the invention, the or each first substrate layer may have a substantially polytetrafluoroethylene-based composition. In such embodiments, the or each first substrate layer may be made from a material that is selected from, but not limited to, a group including Rogers RT Duroid® 5870, Rogers RT Duroid® 5880, Polyflon CuFlon® and Rogers RO3003™.

Polytetrafluoroethylene (PTFE) has a high dielectric strength, a low comparative tracking index and a low dielectric relative permittivity of approximately 2, which renders it compatible for use in the or each first substrate layer. In addition, the comparable dielectric relative permittivities of PTFE-based material and air permit the presence of air voids within the first PCB substrate and/or air gaps between the first PCB substrate and the magnetic core at carefully arranged positions without the risk of partial discharge occurring across the insulation barrier. This obviates the need for a further potting process to cast the entire transformer in resin, thus reducing the complexity and variability of the manufacturing process. Moreover the use of PCB technology enables manufacture of a first PCB substrate with at least one PTFE-based first substrate layer that has little to no air voids.

In still further embodiments of the invention, at least one printed circuit board substrate may include a plurality of substrate layers to define a multi-layered printed circuit board substrate.

The use of one or more PCB substrates with a multi-layered structure allows for the implementation of complex circuitry layouts so as to improve device performance and efficiency, without having to greatly increase the overall footprint size of the transformer. In addition, the windings may be arranged in a variety of ways in a compact manner, whilst maintaining excellent insulation between the windings.

In such embodiments, at least one winding portion may be formed on an intermediate substrate layer of the multi-layered printed circuit board substrate. For example, a high voltage, isolated winding may be formed on an intermediate substrate layer of the multi-layered printed circuit board substrate, so as to provide the required insulation.

In other such embodiments, at least one winding portion may be formed on an outer substrate layer of the multi-layered printed circuit board substrate. At least one winding may be formed from a plurality of winding portions formed on opposite outer surfaces of the outer substrate layers of the multi-layered PCB substrate.

When used in combination with a high voltage winding formed on an intermediate substrate layer, a low voltage winding formed on the outer surfaces of the outer substrate layers of the multi-layered PCB substrate may act as an electrostatic screen to force most of the differential voltage to be across the or each first substrate layer separating the high and low voltage windings.

In embodiments employing the use of a multi-layered printed circuit board substrate, the multi-layered printed circuit board substrate may further include at least one insulating layer, the or each insulating layer being sandwiched between two substrate layers of the multi-layered printed circuit board substrate so as to define a laminated structure of alternating insulating and substrate layers.

The first and second windings may be separated by at least one insulating layer.

The or each insulating layer not only provides additional insulation between the windings, but also may act as an intermediate bonding layer to bond neighbouring substrate layers together. In addition, the or each insulating layer may fully encapsulate, and thereby provide reinforced insulation to, any electrical component formed on intermediate layers of the printed circuit board. For example, at least one insulating layer may coat at least one winding portion.

Preferably the or each insulating layer has a substantially polytetrafluoroethylene-based composition. In such embodiments, the or each insulating layer may be a bonding film. The or each insulating layer may be made from a material that is selected from, but not limited to, a group including WL Gore® Speedboard® C, Arlon CuClad® 6700 and Arlon CuClad® 6250.

The use of at least one PTFE-based insulating layer, together with heat-drawing and/or vacuum-drawing techniques, further minimises the number of air voids in each PCB substrate during its manufacture.

Preferably the transformer further includes at least one electrostatic screen. The or each electrostatic screen may be patterned on a surface of one of the substrate layers. For example, the or each electrostatic screen may be arranged around a high voltage winding to shield a low voltage winding and the magnetic core from capacitive currents that might interfere with signals in the windings. The or each electrostatic screen may be connected to a reference potential so that capacitive currents are drawn away to the reference potential and not into the windings.

The or each electrostatic screen may be in the form of a copper layer that is patterned on the surface of one of the substrate layers and partially surrounds the opening into which the magnetic core is inserted.

In such embodiments, at least one electrostatic screen may be defined by one or more winding portions. In other words, at least one electrostatic screen may simultaneously function as a transformer winding.

A preferred embodiment of the invention will now be described, by way of non-limiting examples, with reference to the accompanying drawings in which:

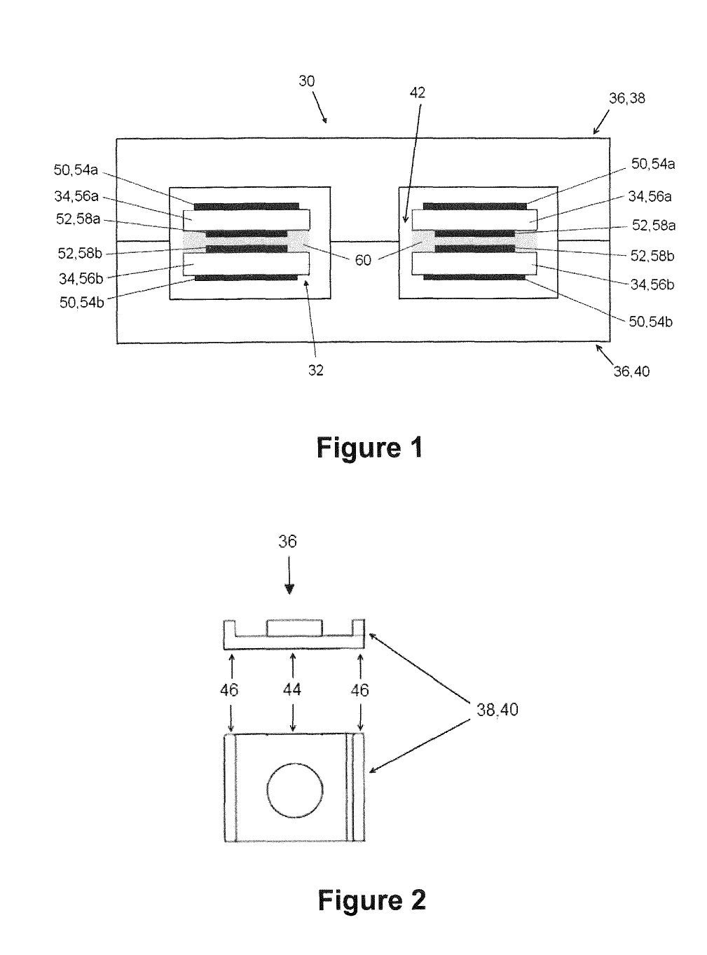

FIG. 1 shows a cross-section of a transformer;

FIG. 2 shows first and second core elements that form part of the magnetic core of FIG. 1;

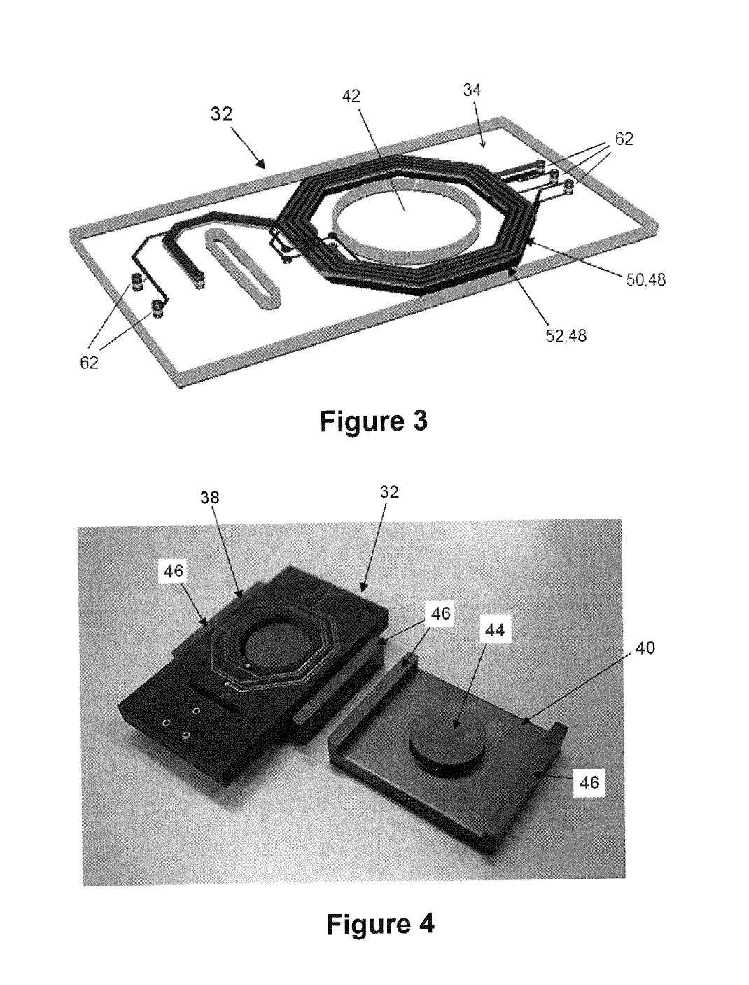

FIG. 3 shows the first PCB substrate of FIG. 1;

FIG. 4 show the first PCB substrate of FIG. 3 and the magnetic core of FIG. 2 in unassembled form;

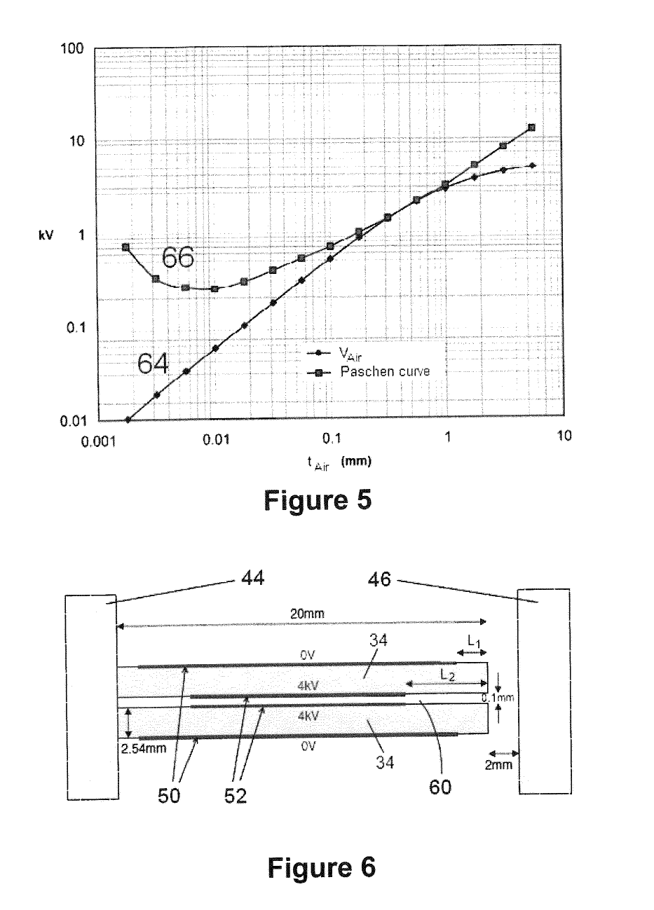

FIG. 5 illustrates the change in voltage across an air void of a modified insulation barrier, for different sizes of the air void, against a Paschen curve for air at standard temperature and pressure;

FIG. 6 shows a finite element model geometry of the cross-section of the transformer shown in FIG. 1;

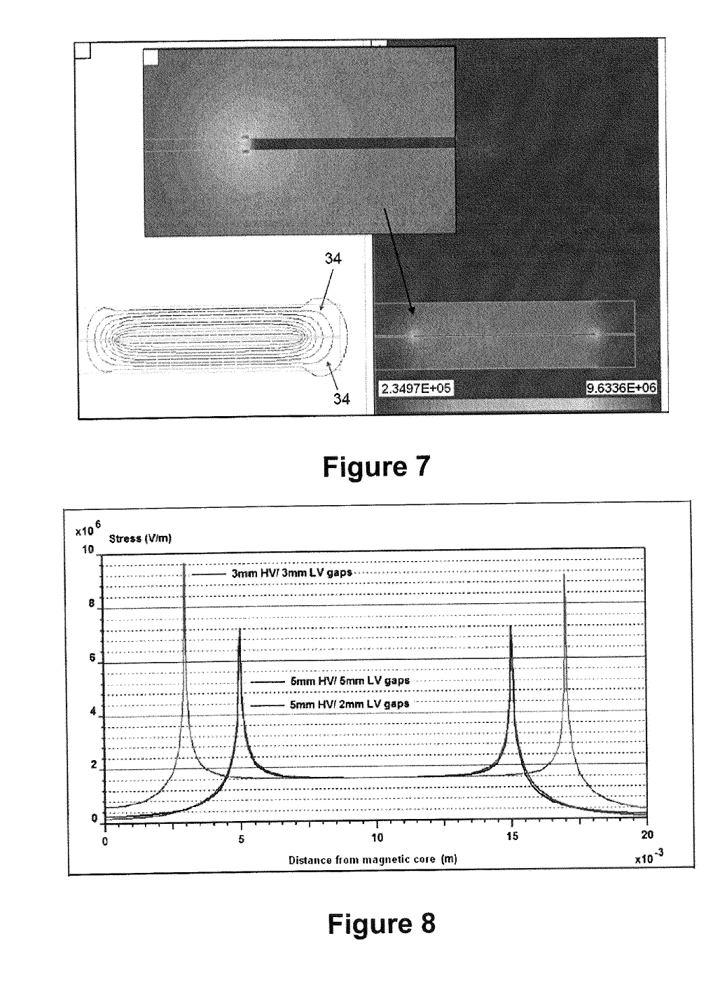

FIGS. 7 and 8 illustrate the variation in voltage stress in the first PCB substrate during operation of the transformer of FIG. 1;

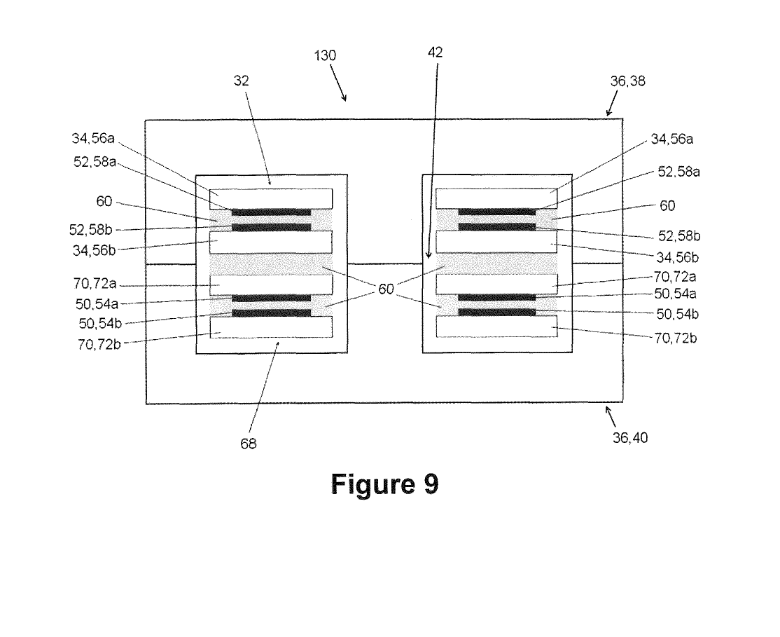

FIG. 9 shows a cross-section of a transformer according to an embodiment of the invention.

A cross-section of a transformer 30 is shown in FIG. 1.

The transformer 30 includes a first printed circuit board (PCB) substrate 32.

The first PCB substrate 32 includes a plurality of first substrate layers 34 to define a multi-layered PCB substrate. Each first substrate layer 34 is made from Rogers RT Duroid® 5870, which is a glass microfiber PTFE material with a dielectric relative permittivity of 2.3.

It is envisaged that each first substrate layer 34 may be made from another material with a substantially PTFE-based composition, such as:
Rogers RT Duroid® 5880 with a dielectric relative permittivity of 2.2,
Polyflon CuFlon®, which is a PTFE material with a dielectric relative permittivity of 2.1, or
Rogers RO3003™, which is a ceramic-filled PTFE composite material with a dielectric relative permittivity of 3.

The transformer 30 further includes a magnetic core 36 having first and second core elements 38,40, and each core element 38,40 has an ER shape, as shown in FIG. 2. The first PCB substrate 32 is shaped so that each first substrate layer 34 has a central opening 42 to receive the magnetic core 36. This allows the magnetic core 36 to be fixed to the first PCB substrate 32 by inserting the middle legs 44 of the first and second core elements 38,40 into the openings 42 respectively from opposite sides of the first PCB substrate 32 such that the outer legs 46 of each core element 38,40 flanks the first PCB substrate 32 on opposite sides.

Preferably the magnetic core 36 has a ferrite-based composition. A ferrite-based magnetic core 36 tends to be easily magnetized as a result of the high magnetic permeability of ferrite-based compositions, which improves the efficiency of the transformer 30 and thereby allows the size of the transformer 30 to be reduced. Other materials with high magnetic permeability may be used in place of the ferrite-based magnetic core 36.

It is envisaged that the shape of the magnetic core 36 and the number of core elements 38,40 may vary to alter the magnetic characteristics of the magnetic core 36 depending on the application of the transformer 30.

The transformer 30 further includes a plurality of electrically conductive traces 48. Each electrically conductive trace 48 is patterned on a surface of one of the first substrate layers 34 to form a winding portion 50,52 that surrounds the opening 42 in the corresponding first substrate layer 34, as shown in FIG. 3. Each winding portion 50,52 has a plurality of turns, each of which surrounds a portion of the magnetic core 36. Since the magnetic field generated by each winding portion 50,52 is proportional to the number of turns of the winding, the number of turns in each winding portion 50,52 may be adjusted to modify the strength of the magnetic field so as to provide optimal performance of the transformer 30.

Preferably each electrically conductive trace 48 is made from copper, which has excellent thermal and electrical characteristics. Each electrically conductive trace 48 may be formed, for example, by etching the traces from a copper sheet laminated onto the surface of the corresponding substrate layer 34. The width of each electrically conductive trace 48 is determined by the magnitude of current that is required to flow through that electrically conductive trace 48. It is envisaged that each electrically conductive trace 48 may be made from other electrically conductive materials.

The plurality of first substrate layers 34 and winding portions 50,52 are arranged in sequence from top to bottom, described as follows with reference to FIG. 1:

A first winding portion 50,54a is formed on a top surface of a top first substrate layer 34,56a.

A bottom first substrate layer 34,56b is arranged below the top first substrate layer 34,56a. Another first winding portion 50,54b is formed on a bottom surface of the bottom first substrate layer 34,56b.

A second winding portion 52,58a is formed on a bottom surface of the top first substrate layer 34,56a, while another second winding portion 52,58b is formed on a top surface of the bottom first substrate layer 34,56b.

The first PCB substrate 32 further includes an insulating layer 60, which is sandwiched between the top and bottom first substrate layers 34,56a,56b of the first PCB substrate 32 so as to define a laminated structure of alternating insulating and first substrate layers 60,34.

The insulating layer 60 is made from WL Gore® Speedboard® C, which is made from expanded PTFE impregnated with thermosetting resins. WL Gore® Speedboard® C has a dielectric relative permittivity of 2.6, a dielectric strength of 1 kV/mm and a melting point of 220° C.

It is envisaged that the insulating layer 60 may be made from another material with a substantially PTFE-based composition, such as:
Arlon CuClad® 6700 with a dielectric relative permittivity of 2.35, a dielectric strength of 2.5 kV/mm and a melting point of 220-230° C., or
Arlon CuClad® 6250 with a dielectric relative permittivity of 2.35, a dielectric strength of 1.0 kV/mm and a melting point of 125-130° C.

To form the first PCB substrate 32, the insulating and first substrate layers 60,34 undergo a lamination process, which may involve the use of a machine press to apply mechanical force to the insulating and first substrate layers 60,34, whilst heat is used to melt the insulating layer 60. This allows the insulating layer 60 to flow and fill the space between the top and bottom first substrate layers 34,56a,56b, and thereby act as a bonding layer. The lamination process is carried out in vacuum to minimise the number of air voids in the first PCB substrate 32.

Lamination of the insulating and first substrate layers 60,34 in this manner results in the insulating layer 60 encapsulating the second winding portions 52 formed on the surfaces of the top and bottom first substrate layers 34,56a,56b.

The first winding portions 50 are electrically connected to form a first winding, while the second winding portions 52 are electrically connected to form a second winding. This is achieved by fabricating vias 62 in the first PCB substrate 32 to electrically connect the first and second winding portions 50,52 respectively, and plating the vias 62 with electrically conductive material, as shown in FIG. 3. Vias 62 are also required to electrically access the buried second winding portions 52.

Each via 62 may be fabricated in the first PCB substrate 32 using a drilling process. The high melting point of the insulating layer 60 prevents the thermosetting resin from melting and smearing the inside walls of the vias 62, when the drilling process causes an increase in temperature. This in turn allows a subsequent plating process to connect properly to each via's internal layers.

FIG. 4 shows the first PCB substrate 32 of FIG. 3 and the magnetic core 36 of FIG. 2 in unassembled form.

To assemble the first PCB substrate 32 and the magnetic core 36 to form the transformer 30, end surfaces of the legs 44,46 of the first core element 38,40 are abutted to end surfaces of the corresponding legs 44,46 of the second core element 38,40 so as to form the shape of the assembled magnetic core 36. The core elements 38,40 are joined together using an adhesive between the abutted surfaces.

Optionally the core elements 38,40 may be joined together using a fastener, e.g. a clip or bracket, to secure the core elements 38,40 together.

The ratio of the number of turns in the first winding to the number of turns in the second winding determines the ratio of the voltages across the two windings.

It is envisaged that each winding may have a different number of turns to that of the other winding, which results in the possibility of stepping up or down the transferred voltage through magnetic coupling of the different windings.

The insulating and first substrate layers 60,34 that separate the first and second windings form a PTFE-based insulation barrier between the different windings. Similarly, a length of each first substrate layer 34 that separates each winding and the magnetic core 36 forms another PTFE-based insulation barrier between each winding and the magnetic core 36. The high dielectric strength of the insulating and first substrate layers 60,34 allows the insulation barriers to withstand the differential voltages that are applied, in use, between the first and second windings and between each winding and the magnetic core 36. This thereby prevents the occurrence of partial discharge and electrical breakdown in the transformer 30.

In addition, by virtue of being formed between the top and bottom first substrate layers 34,56a,56b of the first PCB substrate 32 and being encapsulated by the insulating layer 60, the second winding is provided with reinforced insulation and thereby may be connected to a high voltage. This makes it possible to place a long-term high voltage stress between the different windings with minimal partial discharge activity, resulting in a reliable insulation barrier with a long lifetime.

The use of PCB technology enables manufacture of the first PCB substrate 32 with little to no air voids in its first substrate layers 34. Also, the use of a PTFE-based insulating layer 60, together with heat-drawing and vacuum-drawing techniques, further minimises the number of air voids in the first PCB substrate 32 during its manufacture.

In practice, the insulation barrier between the different windings may include air voids, which are formed in the insulating and/or first substrate layers 60,34 as a result of manufacturing tolerances. Furthermore, the insulation barrier between each winding and the magnetic core 36 may further include a clearance air gap that is formed between the magnetic core 36 and the first PCB substrate 32. The clearance air gap may be formed as part of the transformer design, or may arise unintentionally due to movement of the magnetic core 36 relative to each winding. Also, movement of the magnetic core 36 relative to each winding may cause the clearance air gap to vary in size.

The formation of these air voids and the clearance air gap therefore results in modified insulation barriers that include different dielectrics in the form of PTFE-based and air components.

The differential voltage applied across each modified insulation barrier is shared among the PTFE-based and air components using resistive and capacitive voltage division. In most cases, the effects of capacitive voltage division are dominant over that of resistive voltage division. The voltage across each of the PTFE-based and air components is therefore largely determined by the capacitance and therefore the dielectric relative permittivity of each individual component.

As mentioned above, Rogers RT Duroid® 5870 has a dielectric relative permittivity of 2.3 and WL Gore® Speedboard® C has a dielectric relative permittivity of 2.6, while air has a dielectric relative permittivity of 1. The comparable dielectric relative permittivities of these PTFE-based materials and air leads to a more balanced voltage division between the corresponding insulating and first substrate layers 60,34 and air components. As such, the use of PTFE-based material minimises the voltage per unit length across any air voids in the modified insulation barriers and thereby reduces the risk of partial discharge and electrical breakdown.

In comparison, the relatively high dielectric relative permittivities of other PCB material such as FR-4 and epoxy resin would result in a higher voltage per unit length across the air voids and gap, and thereby causes electrical breakdown within the air voids and gap. This may damage the insulation barrier and cause eventual failure of the transformer 30.

The use of insulating and first substrate layers 60,34 with a substantially PTFE-based composition therefore provides a reliable insulation barrier between the first and second windings and between each winding and the magnetic core 36. This thereby allows higher differential voltages to be applied across the respective insulation barrier, which results in a planar transformer 30 with increased isolation for signal or power transfer.

FIG. 5 illustrates an analysis of a modified insulation barrier, in which a voltage curve 64 showing a change in voltage V_{Air} across an air void of a modified insulation barrier, for different sizes of the air void, is compared against a Paschen curve 66 for air at standard temperature and pressure.

In this analysis, the modified insulation barrier includes PTFE-based and air components, and has an thickness of 1.1 mm. The PTFE-based component has a dielectric relative permittivity of 2.1.

A voltage of 3 kV is applied across the modified insulation barrier. It is assumed that the electric field across the modified insulation barrier is laminar and that there are no surface discharge and polarization effects.

The change in voltage across the air void is calculated as follows:

$${V}_{Air} = \frac{{V}_{Total}}{1 + \frac{{t}_{Insulator}}{{t}_{Air} \times {ɛ}_{Insulator}}}$$

Where
V_{Air} is the voltage across the air void;
V_{Total} is the voltage applied across the modified insulation barrier;
t_{Insulator} and t_{Air} are the sizes of the PTFE-based component and air void respectively;
∈_{Insulator} is the dielectric relative permittivity of the PTFE-based component.

Electrical breakdown occurs when the voltage curve 64 across the air void meets or exceeds the Paschen curve 66 for air. It is shown in FIG. 5 that the voltage curve 64 meets the Paschen curve 66 when the size t_{Air} of the air void is approximately between 0.3 mm and 0.8 mm. This indicates the approximate range for the size t_{Air} of the air void that can be present in the modified insulation barrier to reliably avoid electrical breakdown. In other words, the size t_{Air} of the air void can be smaller than 0.3 mm or larger than 0.8 mm to reliably avoid electrical breakdown in the modified insulation barrier.

A finite element model analysis was carried out to study the voltage stresses across the first PCB substrate 32 during operation of the transformer 30 shown in FIG. 1. In particular, the analysis was carried out to study the voltage stresses from an edge of each winding portion 50,52 formed on the first PCB substrate 32 to the outer leg 46 of the ferrite core 36. FIG. 6 shows a finite element model geometry used in the analysis.

Each first substrate layer 34 has a thickness of 2.54 mm. An outer edge of each first substrate layer 34 is separated from an outer leg 46 of the ferrite core 36 by an air gap of 2 mm. The distance between the opening 42 and the outer edge of each first substrate layer 34 is 20 mm.

Each winding portion 50,52 has a thickness of 35 μm. The distance L₁ between each first winding portion 50 and the outer edge of the corresponding first substrate layer 34 is set to 2 mm, 3 mm or 5 mm. The distance L₂ between each second winding portion 52 and the outer edge of the corresponding first substrate layer 34 is set to 3 mm or 5 mm.

The top and bottom first substrate layers 34,56a,56b are separated by a gap of 0.1 mm. As mentioned above, the insulating layer 60 between the top and bottom first substrate layers 34,56a,56b has a dielectric relative permittivity of 2.3.

The first winding and the ferrite core 36 is connected to a voltage of 0 V, while the second winding is connected to a voltage of 4 kV.

It was assumed that there were no surface discharge and polarisation effects, and that the insulating layer 60 between the top and bottom first substrate layers 34,56a,56b was free of air voids.

FIG. 7 illustrates voltage contours and stress distribution in the first PCB substrate 32 when L₁=3 mm and L₂=3 mm, while FIG. 8 illustrates the voltage stress distribution in the first PCB substrate 32 for different values for L₁ and L₂, based on the analysis of the finite element model geometry shown in FIG. 6.

FIGS. 7 and 8 show that the maximum voltage stress in the first PCB substrate 32 is approximately 9.6 kV/mm and the voltage stress at the outer edge of each first substrate layer 34 is approximately 700 V/mm when L₁=3 mm and L₂=3 mm.

FIG. 8 also shows that the maximum voltage stress in the first PCB substrate 32 is approximately 7.2 kV/mm and the voltage stress at the outer edge of each first substrate layer 34 is approximately 200 V/mm when L₁=2 mm or 5 mm and L₂=5 mm.

It is therefore shown that the use of the PTFE-based first PCB substrate 32 in the transformer 30 minimises the voltage stress in the air gap between each first substrate layer 34 and the magnetic core 36.

In addition to the provision of a reliable insulation barrier in the transformer 30, the use of PCB technology allows for high volume manufacturing, unlike hand-crafted potting and vacuum impregnation methods which tend to be used in low production volumes due to difficulty in achieving the required high voltage insulation. The use of PCB technology also allows for simple design of the transformer structure at relatively low cost when required to scale up to meet higher voltage requirements.

Furthermore, transformers based on PCB technology are lightweight and relatively small in size, and thereby are easily accommodated on or as part of a PCB substrate that contains other electronic circuits to simplify the overall converter assembly. The compact profile and low weight of the planar transformer 30 also leads to an overall reduction in size and weight of a converter, into which the planar transformer 30 may be incorporated.

A transformer 130 according to an embodiment of the invention is shown in FIG. 9. The embodiment of the transformer 130 shown in FIG. 9 is similar in structure and operation to the transformer 30 shown in FIG. 1, and like features share the same reference numerals.

The third transformer 130 differs from the first transformer 30 in that
the third transformer 130 further includes a second PCB substrate 68. The second PCB substrate 68 includes a plurality of second substrate layers 70, each of which is shaped to have a central opening 42 to receive the magnetic core 36. Each second substrate layer 70 is made from FR-4, which has a dielectric relative permittivity in the range of 4.5 to 5; and
each first winding portion 50 is formed on a surface of one of the second substrate layers 70.

The first substrate layers 34, second substrate layers 70 and winding portions 50,52 are arranged in sequence from top to bottom, described as follows with reference to FIG. 9:

A second winding portion 52,58a is formed on a bottom surface of a top first substrate layer 34,56a.

A bottom first substrate layer 34,56b is arranged below the top first substrate layer 34,56a. Another second winding portion 52,58b is formed on a top surface of the bottom first substrate layer 34,56b.

A top second substrate layer 70,72a is arranged below the bottom first substrate layer 34,56b. A first winding portion 50,54a is formed on a bottom surface of the top second substrate layer 70,72a.

A bottom second substrate layer 70,72b is arranged below the top second substrate layer 70,72a. Another first winding portion 50,54b is formed on a top surface of the bottom second substrate layer 70,72b.

The first and second PCB substrates 32,68 further include a plurality of insulating layers 60, each of which is sandwiched between two successive substrate layers 34,70 of the first and second PCB substrates 32,68 so as to define a laminated structure of alternating insulating and substrate layers 60,34,70.

Lamination of the insulating, first and second substrate layers 60,34,70 in this manner results in the plurality of insulating layers 60 encapsulating the first and second winding portions 50,52 formed on the surfaces of the first and second substrate layers 34,70, and bonding the first and second PCB substrates 32,68 together.

The combination of the first and second PCB substrates 32,68 to form the second transformer 130 is advantageous in that the first PCB substrate 32 is able to provide the high voltage, second winding with reinforced insulation via the insulating and first substrate layers 60,34, while the second PCB substrate 68 is able to accommodate the low voltage, first winding, for which insulation is not critical. This results in an economical transformer 130 due to the use of low cost FR-4 material in the second PCB substrate 68.

It is envisaged that one of the first winding portions 50 may be formed on a surface of one of the first substrate layers 34.

It is also envisaged that the number of winding portions 50,52 in the transformer 30,130 may vary depending on the number of turns required for each winding. To accommodate additional winding portions 50,52, each PCB substrate 32,68 may include additional substrate layers 34,70 on which the additional winding portions 50,52 may be formed.

In the transformer of FIG. 1 and the embodiment shown here, at least one winding portion may additionally function as an electrostatic screen. For example, the arrangement of the first and second windings allows the first winding to act as an electrostatic screen to force the differential voltage across the insulation barrier. In addition, the arrangement of the first winding around the second winding reduces leakage inductance during magnetic coupling of the different windings.

It is envisaged that the transformer 30,130 may further include at least one electrostatic screen, wherein the or each electrostatic screen is patterned on a surface of one of the substrate layers 34,70. For example, the or each electrostatic screen may be arranged around a high voltage winding to shield a low voltage winding and the magnetic core 36 from capacitive currents that might interfere with signals in the windings. The or each electrostatic screen may be connected to a reference potential so that capacitive currents are drawn away to the reference potential and not into the windings.

The or each electrostatic screen may be in the form of a copper layer that is patterned on the surface of one of the substrate layers 34,70 and partially surrounds the opening 42 into which the magnetic core 36 is inserted.

1. A transformer comprising:
first and second printed circuit board substrates, the first printed circuit board substrate including at least one first substrate layer having a dielectric relative permittivity of less than or equal to 3.5 and the second printed circuit board substrate including at least one second substrate layer having a dielectric relative permittivity that is higher than the dielectric relative permittivity of the or each first substrate layer; and
a plurality of electrically conductive traces, at least one electrically conductive trace being patterned on a surface of the first substrate layer or one of the first substrate layers to form a second winding portion and at least one other electrically conductive trace being patterned on a surface of the second substrate layer or one of the second substrate layers to form a first winding portion, the first and second winding portions defining mutually coupled first and second windings,
wherein the first winding is formed by one or more first winding portions, the second winding is formed by one or more second winding portions, the second winding is formed on the first substrate layer or at least one of the first substrate layers, and the first winding is formed on the second substrate layer or at least one of the second substrate layers.

2. A transformer according to claim 1 wherein the first winding is separated from the second winding by at least one first substrate layer.

3. A transformer according to claim 1 further including a magnetic core, wherein each printed circuit board substrate is shaped to include one or more openings to receive the magnetic core.

4. A transformer according to claim 1 wherein the or each first substrate layer has a substantially polytetrafluoroethylene-based composition.

5. (canceled)

6. A transformer according to claim 1 wherein at least one printed circuit board substrate includes a plurality of substrate layers to define a multi-layered printed circuit board substrate.

7. A transformer according to claim 6 wherein at least one winding portion is formed on an intermediate substrate layer of the multi-layered printed circuit board substrate.

8. A transformer according to claim 6 wherein at least one winding portion is formed on an outer substrate layer of the multi-layered printed circuit board substrate.

9. A transformer according to claim 6, wherein the multi-layered printed circuit board substrate further includes at least one insulating layer, the or each insulating layer being sandwiched between two substrate layers of the multi-layered printed circuit board substrate so as to define a laminated structure of alternating insulating and substrate layers.

10. A transformer according to claim 9 wherein the first and second windings are separated by at least one insulating layer.

11. A transformer according to claim 9 wherein at least one insulating layer coats at least one winding portion.

12. A transformer according to claim 9 wherein the or each insulating layer has a substantially polytetrafluoroethylene-based composition.

13. (canceled)

14. A transformer according to claim 1 further including at least one electrostatic screen, wherein the or each electrostatic screen is patterned on a surface of one of the substrate layers.

15. A transformer according to claim 14 wherein at least one electrostatic screen is defined by one or more winding portions.
